(19) United States
(12) Patent Application Publication
(10) Pub. No.: US 2012/0109462 A1
(43) Pub. Date: May 3, 2012

(54) LANE KEEPING CONTROL SYSTEM, LANE CHANGE CONTROL SYSTEM AND VEHICLE CONTROL SYSTEM

(75) Inventor: Dae Gun HONG, Seoul (KR)

(73) Assignee: MANDO CORPORATION

(21) Appl. No.: 13/283,186

(22) Filed: Oct. 27, 2011

(30) Foreign Application Priority Data
Oct. 29, 2010 (KR) 10-2010-0107115

(51) Int. Cl. B62D 6/00

(52) U.S. Cl. 701/41

(57) ABSTRACT

Disclosed is control technologies related to lane keeping and lane change including a lane keeping control system, a lane change control system and a vehicle control system, which automatically suppress lane change to ensure safe lane change even if a driver fails to hear a warning sound or see a warning screen and does not recognize a situation in which lane change is dangerous.

### CROSS-REFERENCE TO RELATED APPLICATION

This application claims the benefit of Korean Patent Application No. 2010-0107115, filed on Oct. 29, 2010 in the Korean Intellectual Property Office, the disclosure of which is incorporated herein by reference.

### BACKGROUND

1. Field

Embodiments of the present invention relate to lane keeping control and lane change control.

2. Description of the Related Art this Term is Commonly Used in the Art

Conventional systems assist in issuing a warning upon judging that there is a danger as to lane change by detecting that a vehicle is traveling at a left or right lane of the driver.

Since these conventional systems perform only a passive action to simply issue a warning about a situation in which lane change is dangerous, if the driver fails to hear a warning sound or see a warning screen and does not recognize a situation in which lane change is dangerous, a collision with other vehicles may occur.

### SUMMARY

Therefore, it is an aspect of the present invention to automatically suppress lane change to thereby ensure safe lane change, even if a driver fails to hear a warning sound or see a warning screen and does not recognize a situation in which lane change is dangerous.

Additional aspects of the invention will be set forth in part in the description which follows and, in part, will be obvious from the description, or may be learned by practice of the invention.

In accordance with one aspect of the present invention, a lane keeping control system includes a lane change danger information confirmation unit, which judges, as a result of confirming lane change danger information set based on a lateral/rear vehicle sensing result of a first sensor, whether the lane change danger information is set to a value representing that lane change is dangerous or a value representing that lane change is not dangerous, and a lane keeping steering control unit, which performs steering control for lane keeping to suppress lane change if it is judged that the lane change danger information is set to the value representing that lane change is dangerous, or releases the steering control for lane keeping to allow lane change if it is judged that the lane change danger information is set to the value representing that lane change is not dangerous.

In accordance with another aspect of the present invention, a lane change control system includes a lane change danger information setting unit, which sets lane change danger information based on a lateral/rear vehicle sensing result obtained via a first sensor, a lane change suppression control unit, which performs a lane change warning process and outputs a command signal to allow lane keeping control for suppression of lane change if the lane change danger information is set to a value representing that lane change is dangerous, and a lane change allowance control unit, which outputs a command signal to release lane keeping control for allowance of lane change if the lane change danger information is set to a value representing that lane change is not dangerous.

In accordance with a further aspect of the present invention, a vehicle control system includes a lane change control system, which sets lane change danger information based on a lateral/rear vehicle sensing result obtained via a first sensor and performs a lane change warning process if lane change is dangerous as a result of confirming the set lane change danger information, and a lane keeping control system, which senses a lane departure event based on one or more of lane sensing result information obtained from a second sensor and vehicle status information, and performs steering control for lane keeping based on the lane sensing result information obtained from the second sensor if lane change is dangerous as a result of confirming the lane change danger information, or releases the steering control for lane keeping if lane change is not dangerous.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram of a lane keeping control system according to an embodiment of the present invention;

FIG. 2 is a view illustrating a lane change situation of a vehicle equipped with the lane keeping control system according to the embodiment of the present invention and a vehicle not equipped with the lane keeping control system;

FIG. 3 is a flowchart of a lane keeping control method of the lane keeping control system according to an embodiment of the present invention;

FIG. 4 is a block diagram of a lane change control system according to an embodiment of the present invention; and

FIG. 5 is a block diagram of a vehicle control system according to an embodiment of the present invention.

### DETAILED DESCRIPTION

Reference will now be made in detail to the embodiments of the present invention, examples of which are illustrated in the accompanying drawings, wherein like reference numerals refer to like elements throughout. In the drawings, the same or similar elements are denoted by the same reference numerals even though they are depicted in different drawings. In the following description of the present invention, a detailed description of known functions and configurations incorporated herein will be omitted when it may make the subject matter of the present invention unclear.

It will be understood that although the terms first, second, A, B, (a), (b), etc., may be used herein to describe various elements, the nature and sequence of these elements should not be limited by these terms. These terms are only used to distinguish one element from another element. Additionally, it will be understood that when an element is referred to as being “connected to,” “electrically connected to,” or “coupled to” another element, it may be directly connected to, electrically connected to, or coupled to the other elements or intervening components may be present.

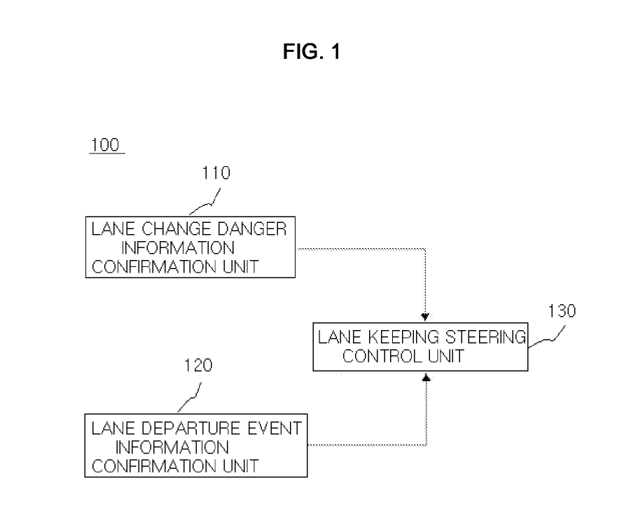

FIG. 1 is a block diagram of a lane keeping control system 100 according to an embodiment of the present invention.

The lane keeping control system 100 according to the embodiment of the present invention controls a vehicle equipped with the lane keeping control system 100 so that the vehicle stays in the same lane.

As illustrated in FIG. 1, according to the embodiment of the present invention, the lane keeping control system 100 may include, e.g., a lane change danger information confirmation unit 110 and a lane keeping steering control unit 130. The lane change danger information confirmation unit 110, which judges, as a result of confirming lane change danger information set based on a lateral/rear vehicle sensing result obtained from a first sensor, whether the lane change danger information is set to a value representing that lane change is dangerous or a value representing that lane change is not dangerous. The lane keeping steering control unit 130 performs steering control for lane keeping to suppress lane change if it is judged that the lane change danger information is set to the value representing that lane change is dangerous, and releases the steering control for lane keeping to allow lane change if it is judged that the lane change danger information is set to the value representing that lane change is not dangerous.

The aforementioned “first sensor” is a sensor that senses vehicles at the lateral and rear sides of a vehicle equipped with the lane keeping control system 100. The first sensor may include at least one radar sensor mounted at a predetermined position (i.e. a left position, right position, rear left position and rear light position) of the vehicle equipped with the lane keeping control system 100.

The aforementioned “lateral/rear vehicle sensing result” from the first sensor relates to details of vehicles traveling at the lateral and rear sides of the vehicle equipped with the lane keeping control system 100, and may include information on the velocity of the lateral and rear vehicles, distances from the lateral and rear vehicles, and the like.

The aforementioned “lane change danger information” may be set based on the lateral/rear vehicle sensing result. For example, if it is confirmed based on the lateral/rear vehicle sensing result that a lateral or rear vehicle is traveling within a predetermined distance (i.e., a distance dangerous for lane change) in a lane that a driver wants to move to (e.g., a left lane or a right lane), the lane change danger information is set to a value representing that lane change is dangerous (e.g., LANE CHANGE WARNING==TRUE). If it is confirmed based on the lateral/rear vehicle sensing result that no lateral or rear vehicle is traveling within a predetermined distance (a distance dangerous for lane change) in a lane that a driver wants to move to (e.g., a left lane or a right lane), the lane change danger information is set to a value representing that lane change is not dangerous (e.g., LANE CHANGE WARNING==FALSE).

The lane change danger information may be obtained in a self setting manner by the lane keeping control system 100, or may be set by a lane change control system which interacts with the lane keeping control system 100.

Referring again to FIG. 1, the lane keeping control system 100 according to the embodiment of the present invention may further include a lane departure event information confirmation unit 120, which confirms lane departure event information set based on a lane sensing result of a second sensor.

The aforementioned “second sensor” is a sensor that senses a lane in which the vehicle equipped with the lane keeping control system 100 is traveling by sensing a lane mark, etc. The second sensor may include a camera sensor that is included in the lane keeping control system 100 and functions to sense a lane based on an image.

The aforementioned “lane departure event information” may be set to a value representing that a lane departure event occurs (e.g., LANE DEPARTURE==TRUE), or a value representing that no lane departure event occurs (e.g., LANE DEPARTURE==FALSE).

In one example, the lane departure event information may be set to a value (TRUE or FALSE) corresponding to the occurrence of a lane departure event determined based on information on the lane mark sensed using the second sensor and vehicle status information obtained from the vehicle (e.g., positional information, left/right turn signal information, etc.).

If it is judged that the lane departure event information from the lane departure event information confirmation unit 120 is set to a value representing that the lane departure event occurs (e.g., LANE DEPARTURE==TRUE) and that the lane change danger information from the lane change danger information confirmation unit 110 is set to a value representing that lane change is dangerous (e.g., LANE CHANGE WARNING==TRUE), the above-described lane keeping steering control unit 130 determines that a lane departure event occurs by lane change performed under the condition that lane change is dangerous and in other words, determines that there is high collision possibility with a vehicle that is traveling in a next lane, thereby performing steering-control for lane keeping so as to suppress lane change.

If it is judged that the lane departure event information from the lane departure event information confirmation unit 120 is set to a value representing that the lane departure event occurs (e.g., LANE DEPARTURE==TRUE) and that the lane change danger information from the lane change danger information confirmation unit 110 is set to a value representing that lane change is not dangerous (e.g., LANE CHANGE WARNING==FALSE), the above-described lane keeping steering control unit 130 determines that a lane departure event occurs under the condition that lane change is not dangerous, thereby releasing steering control for lane keeping so as to allow lane change.

The above-described lane keeping steering control unit 130 may utilize a left turn signal or right turn signal input by the driver when performing steering control for lane keeping.

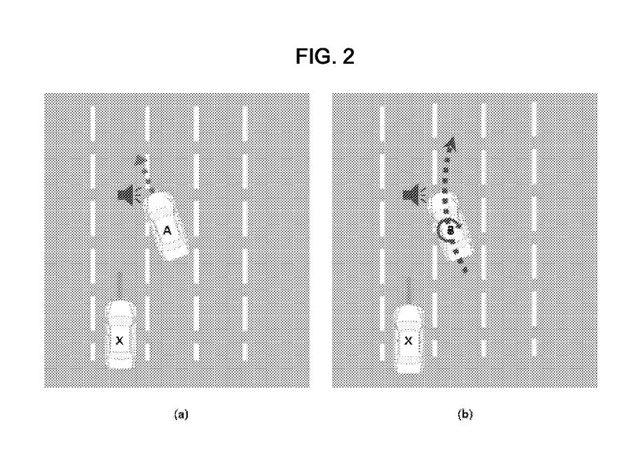

FIG. 2 is a view illustrating a lane change situation of the vehicle equipped with the lane keeping control system 100 according to the embodiment of the present invention and a vehicle not equipped with the lane keeping control system 100.

FIG. 2(a) illustrates the case wherein a vehicle X is traveling in a lane at the left side of a lane in which a vehicle A is traveling, the vehicle X is within a possible collision range with the vehicle A, and the vehicle A, which is not equipped with the lane keeping control system 100 according to the embodiment of the present invention tries to move to the left lane in which the vehicle X is traveling.

Referring to FIG. 2(a), the vehicle A, which is not equipped with the lane keeping control system 100 according to the embodiment of the present invention, only has a function to sense the presence of the vehicle X so as to issue a warning about a situation in which lane change is dangerous (e.g., an audibal process (warning sound), a visual process (warning screen), etc.), and does not perform any control to suppress lane change. Accordingly, if a driver of the vehicle A fails to hear a warning sound or see a warning screen and does not recognize a situation in which lane change is dangerous, a traffic accident between the vehicle A and the vehicle X may occur.

FIG. 2(b) illustrates the case wherein the vehicle X is traveling in a lane at the left side of a lane where a vehicle B is traveling, the vehicle X is within a possible collision range with the vehicle B, and the vehicle B, which is equipped with the lane keeping control system 100 according to the embodiment of the present invention tries to move to the left lane in which the vehicle X is traveling.

Referring to FIG. 2(b), the lane keeping control system 100 according to the embodiment of the present invention performs steering control for lane keeping to suppress lane change so that the vehicle B continues to travel in the lane by confirming lane change danger information (and lane departure event information). Accordingly, even if a driver of the vehicle B fails to hear a warning sound or see a warning screen and does not recognize a situation in which lane change is dangerous, the lane keeping control system 100 according to the embodiment of the present invention allows the vehicle B to stay in the same lane rather than changing lanes, preventing a traffic accident with the vehicle X.

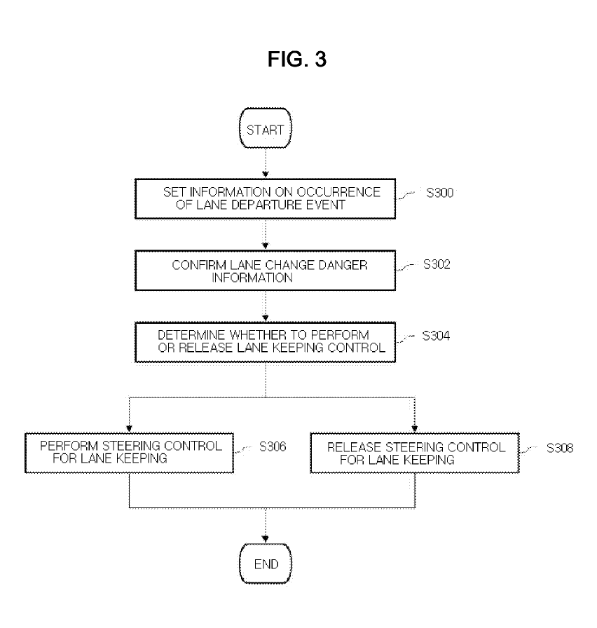

FIG. 3 is a flowchart of a lane keeping control method of the lane keeping control system 100 according to the embodiment of the present invention.

Referring to FIG. 3, the lane keeping control method of the lane keeping control system 100 according to the embodiment of the present invention includes confirming lane change danger information set based on a lateral/rear vehicle sensing result of the first sensor (S302); judging, as a result of confirming the lane change danger information, whether the confirmed lane change danger information is set to a value representing that lane change is dangerous or a value representing that lane change is not dangerous and based on the judged result, determining whether to perform or release steering control for lane keeping (S304); and releasing steering control for lane keeping if it is judged that the lane change danger information is set to the value representing that lane change is dangerous (S308). The method may further include performing steering control for lane keeping so as to suppress lane change (S306) and controlling lane change so as to allow lane change if it is judged that the lane change danger information is set to the value representing that lane change is not dangerous.

As illustrated in FIG. 3, the lane keeping control method of the lane keeping control system 100 according to the embodiment of the present invention may further include confirming lane departure event information set based on a lane sensing result of the second sensor (S300).

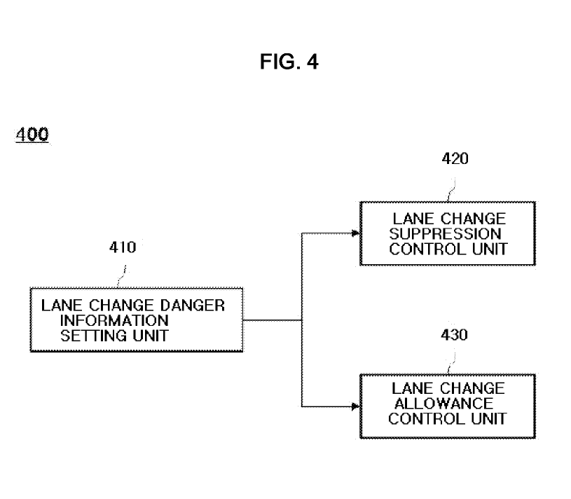

FIG. 4 is a block diagram of a lane change control system 400 according to an embodiment of the present invention.

Referring to FIG. 4, the lane change control system 400 according to the present embodiment includes a lane change danger information setting unit 410, which sets lane change danger information based on a lateral/rear vehicle sensing result obtained from a first sensor, a lane change suppression control unit 420, which performs a lane change warning process and outputs a command signal to allow lane keeping control for suppression of lane change if the lane change danger information is set to a value representing that lane change is dangerous, and a lane change allowance control unit 430, which outputs a command signal to release lane keeping control for allowance of lane change if the lane change danger information is set to a value representing that lane change is not dangerous.

The lane change danger information setting unit 410 may set the lane change danger information based on the lateral/rear vehicle sensing result, the presence of turn signals input by a driver and a direction selected by the driver.

In one example, if the lateral/rear vehicle sensing result shows that a vehicle is traveling in a lane at the left side of a driver within a predetermined distance and the driver inputs a left turn signal to change to the left lane, the lane change danger information setting unit 410 may set the lane change danger information to a value representing that lane change is dangerous.

In another example, if the lateral/rear vehicle sensing result shows that a vehicle is traveling in a lane at the left side of a driver within a predetermined distance and the driver inputs a right turn signal to change to a right lane, the lane change danger information setting unit 410 may set the lane change danger information to a value representing that lane change is not dangerous. In this case, the lane change danger information setting unit 410 may additionally set lane change danger information to indicate that changing to the left lane is dangerous, and issue a warning to the lane change allowance control unit 430.

The command signal to allow lane keeping control output from the lane change suppression control unit 420 may be input to the lane keeping control system 100. Thus, the lane keeping steering control unit 130 of the lane keeping control system 100 performs steering-control for lane keeping.

The command signal to release lane keeping control output from the lane change allowance control unit 430 may be input to the lane keeping control system 100. Thus, the lane keeping steering control unit 130 of the lane keeping control system 100 releases the steering control for lane keeping. If the steering control for lane keeping is released, lane change is performed by the driver.

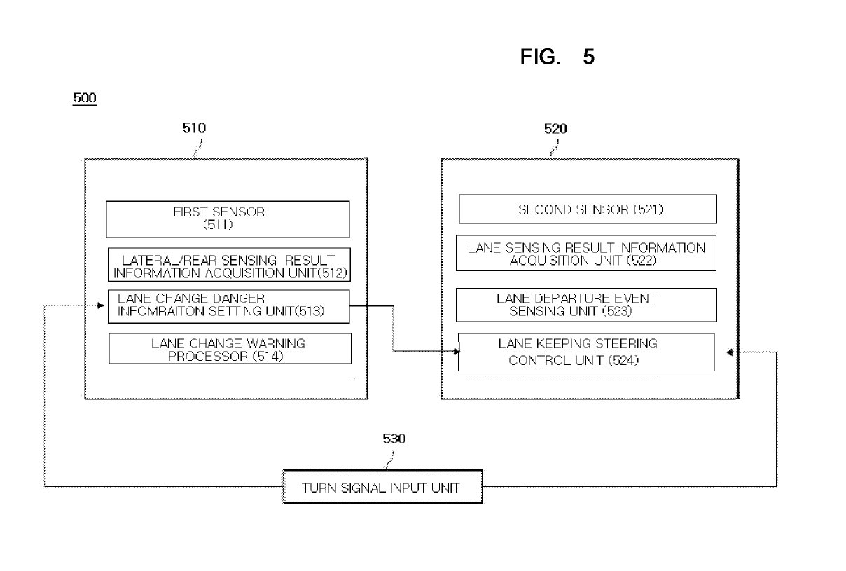

FIG. 5 is a block diagram of a vehicle control system according to an embodiment of the present invention.

Referring to FIG. 5, the vehicle control system 500 according to the embodiment of the present invention includes a lane change control system 510 and a lane keeping control system 520. The lane change control system 510 sets lane change danger information based on information on a lateral/rear vehicle sensing result obtained from a first sensor 511, and performs a lane change warning process if lane change is dangerous as a result of confirming the set lane change danger information. The lane keeping control system 520 senses a lane departure event based on one or more of vehicle status information and information on a lane sensing result obtained from a second sensor 521. The lane keeping control system 520 performs steering control for lane keeping based on the information on the lane sensing result obtained from the second sensor 521 if lane change is dangerous, and releases the steering control for lane keeping if lane change is not dangerous, as a result of confirming the lane change danger information.

Referring to FIG. 5, the vehicle control system 500 according to the embodiment of the present invention may further include a turn signal input unit 530, which receives a left turn or right turn signal input by a driver and transmits the signal to the lane change control system 510 and/or the lane keeping control system 520.

The above-described lane change control system 510 may include, e.g., the first sensor 511, a lateral/rear sensing result information acquisition unit 512 which acquires information based on a lateral/rear vehicle sensing result using the first sensor 511, a lane change danger information setting unit 513 which sets lane change danger information based on a turn signal transmitted from the turn signal input unit 530 and the lateral/rear vehicle sensing result, and a lane change warning processor 514 which performs a lane change warning process (e.g., a visual process, an audibal process and/or a vibrating process) if lane change is dangerous.

The aforementioned lane change danger information setting unit 513 transmits the set lane change danger information to a lane keeping steering control unit 524 of the lane keeping control system 520.

The above-described lane keeping control system 520 may include, e.g., the second sensor 521, a lane sensing result information acquisition unit 522, which acquires information based on a lane sensing result using the second sensor 521, a lane departure event sensing unit 513, which senses a lane departure event based on the lane sensing result and vehicle status information, and a lane keeping steering control unit 524, which performs steering control for lane keeping based on lane sensing result information if lane change is dangerous and releases the steering control for lane keeping if lane change is not dangerous, as a result of confirming the lane change danger information transmitted from the lane change danger information setting unit 513 of the lane change control system 510.

The aforementioned lane change control system 510 may be the lane change control system 400 of FIG. 4, and the lane keeping control system 520 may be the lane keeping control system 100 of FIG. 1.

According to the vehicle control system 500 of the embodiment, the lane change control system 510 may provide safe lane change or suppress lane change using the lane keeping control function of the lane keeping control system 520.

According to the vehicle control system 500 of the embodiment, the lane keeping control system 520 may utilize information on a lane change dangerous situation (i.e. lane change danger information) judged by the lane change control system 510 to control lane keeping.

As is apparent from the above description, according to the embodiment, it is possible to automatically suppress lane change to thereby ensure safe lane change, even if a driver fails to hear a warning sound or see a warning screen and does not recognize a situation in which lane change is dangerous.

Through the embodiments of the present invention as described above, even if a driver fails to heat a warning sound or see a warning screen and does not recognize a lane change dangerous situation, lane change is automatically suppressed, enabling safe lane change.

In the above description, all elements of the embodiments have been described as being combined into one or as being operated in a combined state, but the embodiments are not limited thereto. That is, all the above elements may be selectively combined into one or more structures and be operated within the scope of the embodiments. In addition, although all the elements may be embodied respectively into a single piece of independent hardware, some or all of the elements may be selectively combined so as to be embodied as a computer program having a program module that performs a combination of some or all of the functions into one or a plurality of hardware. Codes and segments constituting the computer program will be easily deduced by those skilled in the art. The computer program is stored in a computer readable storage medium so as to be read and executed by a computer, realizing the embodiments of the present invention. The storage medium for the computer program may include a magnetic recording medium, an optical recording medium, a carrier wave medium, etc.

It will be further understood that the terms “comprises,” “includes,” or “has,” when used in this specification, specify the presence of stated elements unless the context clearly indicates otherwise, and do not preclude the presence of one or more other elements. All terms including technical and scientific terms used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Although a few embodiments of the present invention have been shown and described, it would be appreciated by those skilled in the art that changes may be made in these embodiments without departing from the principles and spirit of the invention, the scope of which is defined in the claims and their equivalents. Accordingly, the embodiments should not be construed as limited to the embodiments set forth herein. Accordingly, the embodiments should not be construed as being limited to example embodiments set forth herein. Rather, these example embodiments are provided so that this disclosure will be thorough and complete, and will fully convey the scope to those skilled in the art.

What is claimed is:

1. A lane keeping control system comprising:
a lane change danger information confirmation unit, which judges, as a result of confirming lane change danger information set based on a lateral/rear vehicle sensing result of a first sensor, whether the lane change danger information is set to a value representing that lane change is dangerous or a value representing that lane change is not dangerous; and
a lane keeping steering control unit, which performs steering control for lane keeping to suppress lane change if it is judged that the lane change danger information is set to the value representing that lane change is dangerous, or releases the steering control for lane keeping to allow lane change if it is judged that the lane change danger information is set to the value representing that lane change is not dangerous.

2. The system according to claim 1, further comprising a lane departure event information confirmation unit, which confirms lane departure event information set based on lane sensing result information from a second sensor.

3. The system according to claim 2, wherein the lane keeping steering control unit determines that a lane departure occurs by lane change performed under the condition that lane change is dangerous if it is judged that the lane departure event information is set to a value representing that the lane departure event occurs and that the lane change danger information is set to the value representing that lane change is dangerous, thereby performing steering control for lane keeping so as to suppress lane change, and also determines that a lane departure event occurs by lane change performed under the condition that lane change is not dangerous if it is judged that the lane departure event information is set to the value representing that the lane departure event occurs and that the lane change danger information is set to the value representing that lane change is not dangerous, thereby performing steering control for lane keeping so as to allow lane change.

4. A lane change control system comprising:
a lane change danger information setting unit, which sets lane change danger information based on a lateral/rear vehicle sensing result obtained via a first sensor;
a lane change suppression control unit, which performs a lane change warning process and outputs a command signal to allow lane keeping control for suppression of lane change if the lane change danger information is set to a value representing that lane change is dangerous; and
a lane change allowance control unit, which outputs a command signal to release lane keeping control for allowance of lane change if the lane change danger information is set to a value representing that lane change is not dangerous.

5. The system according to claim 4, wherein the lane change danger information setting unit sets the lane change danger information based on the lateral/rear vehicle sensing result, the presence of turn signals input by a driver and a direction selected by the driver.

6. A vehicle control system comprising:
a lane change control system, which sets lane change danger information based on a lateral/rear vehicle sensing result obtained via a first sensor and performs a lane change warning process if lane change is dangerous as a result of confirming the set lane change danger information; and
a lane keeping control system, which senses a lane departure event based on one or more of lane sensing result information obtained from a second sensor and vehicle status information, and performs steering control for lane keeping based on the lane sensing result information obtained from the second sensor if lane change is dangerous as a result of confirming the lane change danger information, or releases the steering control for lane keeping if lane change is not dangerous.
